(19) United States
(12) Patent Application Publication
(10) Pub. No.: US 2024/0056486 A1
(43) Pub. Date: Feb. 15, 2024

(54) RESOURCE POLICY ADJUSTMENT BASED ON DATA CHARACTERIZATION

(71) Applicant: Microsoft Technology Licensing, LLC, Redmond, WA (US)

(72) Inventors: Sagi LOWENHARDT, Herzliya (IL); Andrey KARPOVSKY, Kiryat Motzkin (IL)

(21) Appl. No.: 17/884,674

(22) Filed: Aug. 10, 2022

(51) Int. Cl. H04L 9/40; H04L 47/80; H04L 47/78; H04L 41/16

(52) U.S. Cl. CPC H04L 63/20; H04L 47/803; H04L 47/781; H04L 41/16

(57) ABSTRACT

Some embodiments automatically reduce or remove gaps between a data resource's actual policy and an optimal policy. Policy gaps may arise when a different kind of data is added to the resource after the policy was set, or when the original policy is deemed inadequate, for example. An embodiment obtains a characterization of the resource's data in terms of sensitivity, criticality, or category, captured in scores or labels. The embodiment locates the resource's current policy, and conforms the policy with best practices, by modifying or replacing the policy as indicated. Policy adjustments may implement recommendations that were generated by an artificial intelligence model. Policy adjustments may be periodic, ongoing, or driven by specified trigger events. Policy conformance of particular resource sets may be prioritized. Automated policy conformance improves security, operational consistency, and computational efficiency, and relieves personnel of tedious and error-prone tasks.

### BACKGROUND

Attacks on a computing system may take many different forms, including some forms which are difficult to predict, and forms which may vary from one situation to another. Accordingly, one of the guiding principles of cybersecurity is “defense in depth”. In practice, defense in depth is often pursed by forcing attackers to encounter multiple different kinds of security mechanisms at multiple different locations around or within the computing system. No single security mechanism is able to detect every kind of cyberattack, or able to end every detected cyberattack. But sometimes combining and layering a sufficient number and variety of defenses will deter an attacker, or at least limit the scope of harm from an attack.

To implement defense in depth, cybersecurity professionals consider the different kinds of attacks that could be made against a computing system. They select defenses based on criteria such as: which attacks are most likely to occur, which attacks are most likely to succeed, which attacks are most harmful if successful, which defenses are in place, which defenses could be put in place, and the costs and procedural changes and training involved in putting a particular defense in place. Some defenses might not be feasible or cost-effective for the computing system. However, improvements in cybersecurity remain possible, and worth pursuing.

### SUMMARY

Some embodiments described herein address technical challenges related to securing data efficiently and effectively. In particular, challenges arise when a security policy is not reliably updated to match changes in the sensitivity or criticality of data the policy is supposed to help protect. For example, access policies may have default values or inherited values that are not optimal with regard to the sensitivity or criticality of data that is actually subject to the policy.

In some embodiments, a data resource policy is adjusted proactively by the embodiment, instead of burdening administrators with responsibility for policy updates which would be tedious and which there may be no apparent reason to consider. The embodiment obtains a data resource characterization of a data resource, locates a data resource policy of the data resource, and conforms the data resource policy to the data resource characterization. The resource characterization may involve a data resource criticality, sensitivity, or category, for example, and may be indicated by a label or a score. The policy may specify computational conditions, actions, or prohibitions as to a security token or other resource access mechanism. Conforming the policy to the data resource characterization may involve modifying the policy, replacing it, removing it, or generating a recommendation for specific policy changes, for example.

Other technical activities and characteristics pertinent to teachings herein will also become apparent to those of skill in the art. The examples given are merely illustrative. This Summary is not intended to identify key features or essential features of the claimed subject matter, nor is it intended to be used to limit the scope of the claimed subject matter. Rather, this Summary is provided to introduce—in a simplified form—some technical concepts that are further described below in the Detailed Description. The innovation is defined with claims as properly understood, and to the extent this Summary conflicts with the claims, the claims should prevail.

### DESCRIPTION OF THE DRAWINGS

A more particular description will be given with reference to the attached drawings. These drawings only illustrate selected aspects and thus do not fully determine coverage or scope.

FIG. 1 is a diagram illustrating aspects of computer systems and also illustrating configured storage media;

FIG. 2 is a diagram illustrating aspects of a computing system which has one or more of the data resource policy adjustment enhancements taught herein;

FIG. 3 is a block diagram illustrating an enhanced system configured with data resource policy adjustment functionality;

FIG. 4 is a block diagram illustrating some aspects of data resource policy adjustment; and

FIG. 5 is a flowchart illustrating steps in some data resource policy adjustment methods.

### DETAILED DESCRIPTION

Overview

Innovations may expand beyond their origins, but understanding an innovation's origins can help one more fully appreciate the innovation. In the present case, some teachings described herein were motivated by technical challenges arising from ongoing efforts by Microsoft innovators to help administrators and security officers control and maintain sensitive data.

Microsoft innovators looked beyond data classification to consider some of the next steps that might be taken to help prevent undesired access to data. That is, the innovators sought to define helpful steps to take after sensitive data has been classified and labeled, e.g., classified or labeled to indicate the data's severity or sensitivity. “Severity” may also be referred to as “criticality”, and indicates the importance of the data to particular projects or company missions, or the impact if the data were misused or corrupted or lost. “Sensitivity” may also be referred to as “confidentiality” or as “privacy”, and indicates who is allowed to access to data and under what conditions access is allowed. In some situations, a data “category” is also considered, e.g., specifying a data's origin (department, division, etc.) or a data's usage (litigation hold, exposed during incident XYZ, under regulatory review, etc.).

The innovators explored possibilities for combining data classification with access policies so they would work synergistically together. The innovators recognized that changes in data, or other changes in an environment such as security breaches, could make a policy less suitable over time for the data the policy is relied on to protect. For example, suppose a data resource originally contained low sensitivity data and was therefore matched to a policy that allowed wide access. But over time, data that is more sensitive has been added to the resource. As a result, there is a mismatch.

As another example, suppose a data resource was classified as sensitive, but some sensitive data was exfiltrated during a breach due to a lack of exfiltration monitoring. A management decision was then made to add exfiltration monitoring to all policies that govern access to sensitive data. As a result, the originally matching policy is now a mismatch, even though neither the original policy nor the sensitivity of the data it governs has changed.

Turning back to the example in which higher-sensitivity data was added, there is a risk that the policy will not be updated to provide tighter security that matches the increased sensitivity of the data now stored in the resource. In this particular example, an appropriate change would be to further restrict access under an updated policy. However, in other situations the appropriate policy change might be different, e.g., to remove an access restriction, or to increase or decrease logging, or to start or terminate exfiltration monitoring, and so on.

One approach to reducing mismatches between a resource and its governing policy would be to rely on some person to recognize when policy changes are prudent and then make appropriate changes to the policy. But inconsistency and error risks make this approach ineffective and inefficient.

One person who might be expected to watch for policy mismatches is the owner of the data that is governed by the policy. But the owner of the data resource may not have realized the policy should be updated, or they may have forgotten to update the policy because they are more focused on the data itself and on using the data to move a particular project closer to completion. Even if they remember to check for a policy mismatch, the data owner may be unfamiliar with the relevant tools for security policy administration.

Security policy administration tools would be familiar to the admin or the security officer who is nominally responsible for securing the data. But the data owner probably does not routinely notify the admin or security officer when recently added data is more sensitive than the data on which the original data resource classification was based. It is also unlikely that the admin or security officer has been monitoring each and every change to the particular resource just in case the level of sensitivity or criticality changes and a policy update becomes prudent. Accordingly, the admin or security officer may have no apparent reason to consider changing the policy.

In short, the risk of policy mismatches is significant. Having concluded that relying solely on human action to avoid policy mismatches is not optimal, the innovators explored the possibility of using technical mechanisms to detect, reduce, or avoid mismatches. This led to some technical challenges, such as: specifying the conditions under which the mechanism will check for a possible mismatch between a data resource and the data resource's security policy, specifying the criteria that determine whether the data resource policy no longer matches the data in the resource, and specifying the computational actions to be taken (or not taken) when the mismatch criteria are met.

Some embodiments described herein address these challenges by providing or utilizing mechanisms that proactively conform data resource policies to data characterizations. The data characterizations indicate an actual current (or at least recent) sensitivity, criticality, or category of the data, which the mechanism compares to the current policy governing access to the data. If the characterization and the policy don't match, then the mechanism may suggest policy changes to better align the policy with the data governed by the policy, or it may automatically implement such changes.

Beneficially, these data resource policy adjustments may be triggered periodically, or they may be triggered by data access events. Either embodiment relieves both the data's owner and the admin or security personnel of the burden of manually checking whether a policy adjustment is prudent, and provides greater consistency in policy mismatch detection and reduction.

Another benefit is that data characterizations considered by the policy adjustment embodiments may be specified using scores or labels or both, thereby covering a wider range of data. Similarly, data characterizations may specify data resource sensitivity, criticality, category, or a mixture thereof, which also provides the benefit of covering a wider range of data and supporting greater variation in the policies than can be automatically assessed or adjusted or both.

Yet another benefit is that data resource policies that are monitored for potential adjustment may have policy entries specifying security token conditions, security token prohibitions, or actions that directly or indirectly involve a security token. Accordingly, the policies which can be automatically assessed or adjusted or both include security token policies in these embodiments. Security token policies are widely relied upon, and security tokens are often targets for misuse. Thus, even an incremental improvement in the coordination of security token policies with the data the security tokens are meant to protect can provide a significant security enhancement.

These and other benefits will be apparent to one of skill from the teachings provided herein.

Operating Environments

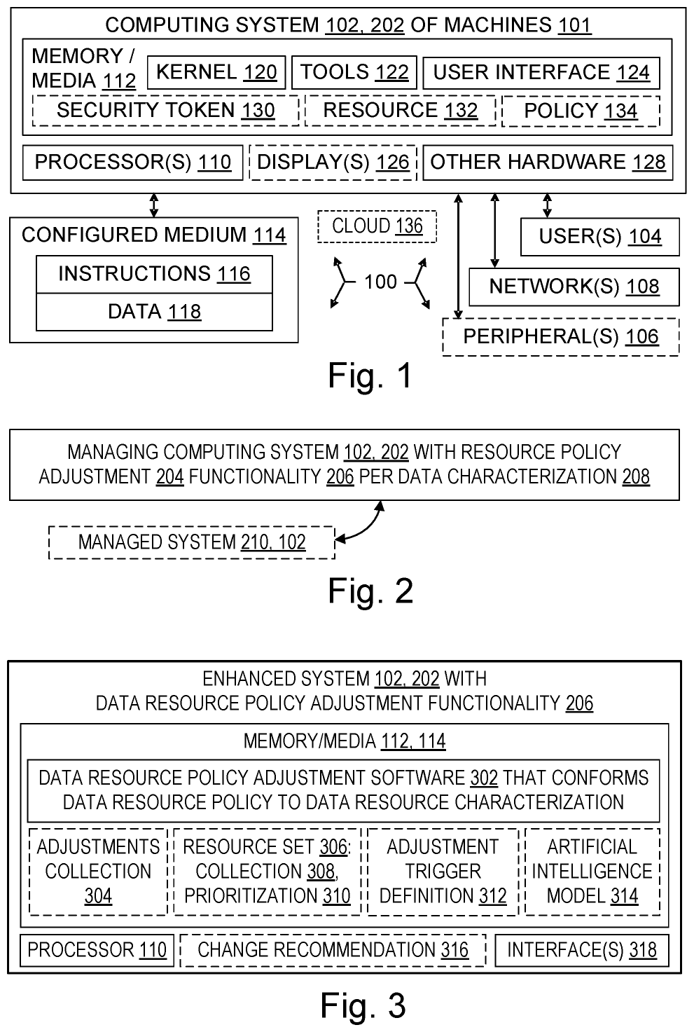

With reference to FIG. 1, an operating environment 100 for an embodiment includes at least one computer system 102. The computer system 102 may be a multiprocessor computer system, or not. An operating environment may include one or more machines in a given computer system, which may be clustered, client-server networked, and/or peer-to-peer networked within a cloud 136. An individual machine is a computer system, and a network or other group of cooperating machines is also a computer system. A given computer system 102 may be configured for end-users, e.g., with applications, for administrators, as a server, as a distributed processing node, and/or in other ways.

Human users 104 may interact with a computer system 102 user interface 124 by using displays 126, keyboards 106, and other peripherals 106, via typed text, touch, voice, movement, computer vision, gestures, and/or other forms of I/O. Virtual reality or augmented reality or both functionalities may be provided by a system 102. A screen 126 may be a removable peripheral 106 or may be an integral part of the system 102. The user interface 124 may support interaction between an embodiment and one or more human users. The user interface 124 may include a command line interface, a graphical user interface (GUI), natural user interface (NUI), voice command interface, and/or other user interface (UI) presentations, which may be presented as distinct options or may be integrated.

System administrators, network administrators, cloud administrators, security analysts and other security personnel, operations personnel, developers, testers, engineers, auditors, and end-users are each a particular type of human user 104. Automated agents, scripts, playback software, devices, and the like running or otherwise serving on behalf of one or more humans may also have accounts, e.g., service accounts. Sometimes an account is created or otherwise provisioned as a human user account but in practice is used primarily or solely by one or more services; such an account is a de facto service account. Although a distinction could be made, “service account” and “machine-driven account” are used interchangeably herein with no limitation to any particular vendor.

Storage devices and/or networking devices may be considered peripheral equipment in some embodiments and part of a system 102 in other embodiments, depending on their detachability from the processor 110. Other computer systems not shown in FIG. 1 may interact in technological ways with the computer system 102 or with another system embodiment using one or more connections to a cloud 136 and/or other network 108 via network interface equipment, for example.

Each computer system 102 includes at least one processor 110. The computer system 102, like other suitable systems, also includes one or more computer-readable storage media 112, also referred to as computer-readable storage devices 112. Tools 122 may include software apps on mobile devices 102 or workstations 102 or servers 102, as well as APIs, browsers, or webpages and the corresponding software for protocols such as HTTPS, for example.

Storage media 112 may be of different physical types. The storage media 112 may be volatile memory, nonvolatile memory, fixed in place media, removable media, magnetic media, optical media, solid-state media, and/or of other types of physical durable storage media (as opposed to merely a propagated signal or mere energy). In particular, a configured storage medium 114 such as a portable (i.e., external) hard drive, CD, DVD, memory stick, or other removable nonvolatile memory medium may become functionally a technological part of the computer system when inserted or otherwise installed, making its content accessible for interaction with and use by processor 110. The removable configured storage medium 114 is an example of a computer-readable storage medium 112. Some other examples of computer-readable storage media 112 include built-in RAM, ROM, hard disks, and other memory storage devices which are not readily removable by users 104. For compliance with current United States patent requirements, neither a computer-readable medium nor a computer-readable storage medium nor a computer-readable memory is a signal per se or mere energy under any claim pending or granted in the United States.

The storage device 114 is configured with binary instructions 116 that are executable by a processor 110; “executable” is used in a broad sense herein to include machine code, interpretable code, bytecode, and/or code that runs on a virtual machine, for example. The storage medium 114 is also configured with data 118 which is created, modified, referenced, and/or otherwise used for technical effect by execution of the instructions 116. The instructions 116 and the data 118 configure the memory or other storage medium 114 in which they reside; when that memory or other computer readable storage medium is a functional part of a given computer system, the instructions 116 and data 118 also configure that computer system. In some embodiments, a portion of the data 118 is representative of real-world items such as events manifested in the system 102 hardware, product characteristics, inventories, physical measurements, settings, images, readings, volumes, and so forth. Such data is also transformed by backup, restore, commits, aborts, reformatting, and/or other technical operations.

Although an embodiment may be described as being implemented as software instructions executed by one or more processors in a computing device (e.g., general purpose computer, server, or cluster), such description is not meant to exhaust all possible embodiments. One of skill will understand that the same or similar functionality can also often be implemented, in whole or in part, directly in hardware logic, to provide the same or similar technical effects. Alternatively, or in addition to software implementation, the technical functionality described herein can be performed, at least in part, by one or more hardware logic components. For example, and without excluding other implementations, an embodiment may include hardware logic components 110, 128 such as Field-Programmable Gate Arrays (FPGAs), Application-Specific Integrated Circuits (ASICs), Application-Specific Standard Products (ASSPs), System-on-a-Chip components (SOCs), Complex Programmable Logic Devices (CPLDs), and similar components. Components of an embodiment may be grouped into interacting functional modules based on their inputs, outputs, and/or their technical effects, for example.

In addition to processors 110 (e.g., CPUs, ALUs, FPUs, TPUs, GPUs, and/or quantum processors), memory/storage media 112, peripherals 106, and displays 126, an operating environment may also include other hardware 128, such as batteries, buses, power supplies, wired and wireless network interface cards, for instance. The nouns “screen” and “display” are used interchangeably herein. A display 126 may include one or more touch screens, screens responsive to input from a pen or tablet, or screens which operate solely for output. In some embodiments, peripherals 106 such as human user I/O devices (screen, keyboard, mouse, tablet, microphone, speaker, motion sensor, etc.) will be present in operable communication with one or more processors 110 and memory 112.

In some embodiments, the system includes multiple computers connected by a wired and/or wireless network 108. Networking interface equipment 128 can provide access to networks 108, using network components such as a packet-switched network interface card, a wireless transceiver, or a telephone network interface, for example, which may be present in a given computer system. Virtualizations of networking interface equipment and other network components such as switches or routers or firewalls may also be present, e.g., in a software-defined network or a sandboxed or other secure cloud computing environment. In some embodiments, one or more computers are partially or fully “air gapped” by reason of being disconnected or only intermittently connected to another networked device or remote cloud. In particular, policy adjustment functionality 206 could be installed on an air gapped network and then be updated periodically or on occasion using removable media 114, or not updated at all. A given embodiment may also communicate technical data and/or technical instructions through direct memory access, removable or non-removable volatile or nonvolatile storage media, or other information storage-retrieval and/or transmission approaches.

One of skill will appreciate that the foregoing aspects and other aspects presented herein under “Operating Environments” may form part of a given embodiment. This document's headings are not intended to provide a strict classification of features into embodiment and non-embodiment feature sets.

One or more items are shown in outline form in the Figures, or listed inside parentheses, to emphasize that they are not necessarily part of the illustrated operating environment or all embodiments, but may interoperate with items in the operating environment or some embodiments as discussed herein. It does not follow that any items which are not in outline or parenthetical form are necessarily required, in any Figure or any embodiment. In particular, FIG. 1 is provided for convenience; inclusion of an item in FIG. 1 does not imply that the item, or the described use of the item, was known prior to the current innovations.

More about Systems

FIG. 2 illustrates a computing system 102 configured by one or more of the data resource policy adjustment enhancements taught herein, resulting in an enhanced system 202. This enhanced system 202 may include a single machine, a local network of machines, machines in a particular building, machines used by a particular entity, machines in a particular datacenter, machines in a particular cloud, or another computing environment 100 that is suitably enhanced. FIG. 2 items are discussed at various points herein, and additional details regarding them are provided in the discussion of a List of Reference Numerals later in this disclosure document.

FIG. 3 illustrates an example enhanced system 202 which is configured with data resource policy adjustment software 302 to provide functionality 206. Software 302 and other FIG. 3 items are discussed at various points herein, and additional details regarding them are provided in the discussion of a List of Reference Numerals later in this disclosure document.

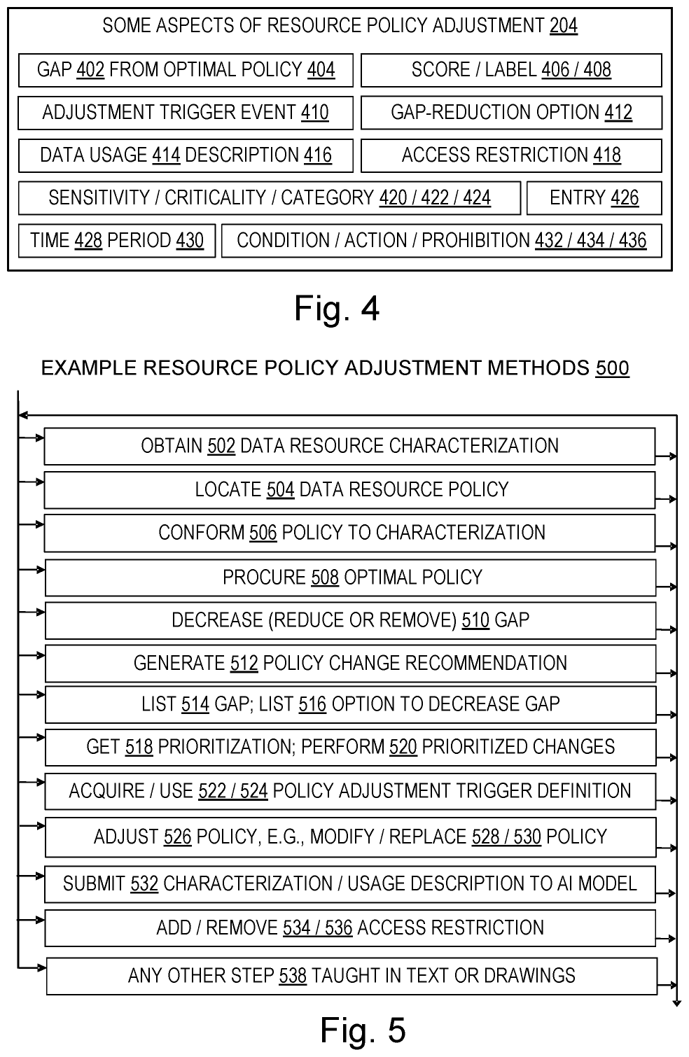

FIG. 4 shows some aspects of data resource policy adjustment 204. This is not a comprehensive summary of all aspects of data resource policy adjustment 204 or all aspects of data resources 132 or all aspects of data resource policies 134. Nor is it a comprehensive summary of all aspects of an environment 100 or system 202 or other context of data resource policy adjustment 204, or a comprehensive summary of all data resource policy adjustment mechanisms for potential use in or with a system 102. FIG. 4 items are discussed at various points herein, and additional details regarding them are provided in the discussion of a List of Reference Numerals later in this disclosure document.

In some embodiments, the enhanced system 202 may be networked through an interface 318. An interface 318 may include hardware such as network interface cards, software such as network stacks, APIs, or sockets, combination items such as network connections, or a combination thereof.

In some embodiments, an enhanced system 202 includes a managing computing system 202 which is configured to manage a data resource policy of a managed system 210. In some cases, the managing computing system 202 and the managed system 210 are disjunct in terms of the machines 101 they respectively include, whereas in other cases they overlap, or one system is contained wholly within the other system, or they are coextensive.

The enhanced system 202 includes a digital memory 112 and at least one processor 110 in operable communication with the memory. In a given embodiment, the digital memory 112 may be volatile or nonvolatile or a mix. The at least one processor is configured to collectively perform data resource policy adjustment 204 based on data characterization 208, including automatically: obtaining 502 a data resource characterization 208 of a data resource 132, locating 504 a data resource policy 134 of the data resource 132, and conforming 506 the data resource policy 134 to the data resource characterization 208.

Some embodiments combine the managing system 202 with the data resource policy 134 of the data resource. In some of these, the data resource policy includes an entry 426 which specifies at least one of the following: a data resource sensitivity 420 characterization 208 (e.g., the policy entry requires multifactor authentication for data classified as secret); a data resource criticality 422 characterization 208 (e.g., the policy entry makes released code read-only); or a data resource category 424 characterization (e.g., the policy entry prohibits litigation-related data from being moved, deleted, or modified).

Some embodiments combine the managing system 202 with the data resource 132 characterization 208. In some of these, the data resource characterization 208 includes at least one of the following: a data resource sensitivity 420 score 406 (e.g., a mean, a max, a proportion of sensitive files, or a sensitivity score that was output by a machine learning model 314); a data resource criticality 422 score 406 (e.g., a mean, a max, a proportion of critical files, or a criticality score that was output by a machine learning model 314); a data resource sensitivity 420 label 408 (e.g., secret or top-secret); a data resource criticality 422 label 408 (e.g., project-critical, enterprise-critical, or noncritical); a data resource category 424 label 408 (e.g., accounting, legal, Project Charlie, etc.); or a set of multiple data resource labels 408 (e.g., secret+critical, top-secret+critical+accounting, etc.).

Some embodiments combine the managing system 202 with a data resource policy 134 of the data resource which involves security tokens 130. In some of these, the data resource policy includes an entry 426 specifying at least one of: a security token condition 432 (e.g., to access a resource governed by this policy, the token presented must be less than five minutes old); an action 434 including a security token (e.g., specified details of a token will be logged); a prohibition 436 including a security token (e.g., no tokens will be generated that allow modifying or deleting this resource); or an action 434 affecting a security token (e.g., any token generated prior to a specified effective data of this policy will be revoked on receipt).

In some embodiments and some scenarios, security tokens are invalidated once sensitive data is detected because in these scenarios security tokens aren't allowed in a policy for sensitive data. In some, a security token expiration is shorter or further limited based on the policy.

One of skill informed by teachings of the present disclosure will acknowledge that embodiments may be selected, configured, or operated to provide various technical benefits. Some of these benefits are highlighted in the following example scenarios. In each scenario, an embodiment obtains 502 a characterization 208 of a data resource 132, locates 504 a data policy 134, and conforms 506 the policy with the data characterization. These scenarios are not focused on an initial creation of a policy. Rather, they illustrate embodiment benefits in situations where a policy exists but is not optimal in view of the data governed by the policy.

Scenario A: Confidential data was added to the resource, but the policy was set for public data. The embodiment updates or replaces the policy so it will protect the confidential data, thereby improving data security.

Scenario B: The resource has always contained confidential data, and the initial policy tried to protect that data, but it has become clear that the initial policy isn't working as desired. The embodiment updates or replaces the old confidential data policy with a new confidential data policy, thereby improving data security.

Scenario C: The managed system 210 was using sensitivity labels, and is being enhanced to also use criticality labels. The embodiment updates or replaces the sensitivity policies to install policies that are based on both sensitivity and criticality, thereby improving data security. For instance, some customer address data that came from public sources was therefore labeled public and therefore was not well protected, but has now been given a campaign-critical label and will be better protected after the policy is updated accordingly.

Scenario D: The managed system 210 was using sensitivity labels, and is being enhanced to also use category labels. The embodiment updates or replaces the sensitivity policies to install policies that are based on both sensitivity and category, thereby improving data security. For instance, all data in finance department accounts was previously labeled as secret even though it might not be secret, e.g., public regulatory documents filed with the government are finance department data but are not secret. Now some of the finance department data is in a category “public regulatory filing”. The embodiment updates or replaces the old accounting data policy with a new policy that makes all of the public regulatory filing data read-only, thereby improving efficiency by only protecting the data to an appropriate extent instead invoking system resources to overprotect the data.

These example scenarios are illustrative, not comprehensive. One of skill informed by the teachings herein will recognize that many other scenarios and many other variations are also taught. In particular, different embodiments or configurations may vary as to the number or grouping or nature of labels 408 or scores 406, for example, and yet still be within the scope of the teachings presented in this disclosure.

Other system embodiments are also described herein, either directly or derivable as system versions of described processes or configured media, duly informed by the extensive discussion herein of computing hardware.

Although specific data resource policy management 204 architecture examples are shown in the Figures, an embodiment may depart from those examples. For instance, items shown in different Figures may be included together in an embodiment, items shown in a Figure may be omitted, functionality shown in different items may be combined into fewer items or into a single item, items may be renamed, or items may be connected differently to one another.

Examples are provided in this disclosure to help illustrate aspects of the technology, but the examples given within this document do not describe all of the possible embodiments. A given embodiment may include additional or different kinds of data characterizations 208, for example, as well as different technical features, aspects, security controls, mechanisms, rules, criteria, expressions, hierarchies, operational sequences, data structures, environment or system characteristics, or other data resource policy adjustment functionality 206 teachings noted herein, and may otherwise depart from the particular illustrative examples provided.

Processes (a.k.a. Methods)

Methods (which may also be referred to as “processes” in the legal sense of that word) are illustrated in various ways herein, both in text and in drawing figures. FIG. 5 illustrates a family of methods 500 that may be performed or assisted by an enhanced system, such as system 202 or another functionality 206 enhanced system as taught herein. FIGS. 1 through 4 show data resource policy management architectures with implicit or explicit actions, e.g., steps for collecting data 118, transferring data 118, storing data 118, and otherwise processing data 118, in which data 118 may include, e.g., policies 134, characterizations 208, and change recommendations 316.

Technical processes shown in the Figures or otherwise disclosed will be performed automatically, e.g., by an enhanced system 202, unless otherwise indicated. Related processes may also be performed in part automatically and in part manually to the extent action by a human person is implicated, e.g., in some embodiments a human 104 may type in a value for the system 202 to use as a data category 424 description. But no process contemplated as innovative herein is entirely manual or purely mental; none of the claimed processes can be performed solely in a human mind or on paper. Any claim interpretation to the contrary is squarely at odds with the present disclosure.

In a given embodiment zero or more illustrated steps of a process may be repeated, perhaps with different parameters or data to operate on. Steps in an embodiment may also be done in a different order than the top-to-bottom order that is laid out in FIG. 5. Arrows in method or data flow figures indicate allowable flows; arrows pointing in more than one direction thus indicate that flow may proceed in more than one direction. Steps may be performed serially, in a partially overlapping manner, or fully in parallel within a given flow. In particular, the order in which flowchart 500 action items are traversed to indicate the steps performed during a process may vary from one performance of the process to another performance of the process. The flowchart traversal order may also vary from one process embodiment to another process embodiment. Steps may also be omitted, combined, renamed, regrouped, be performed on one or more machines, or otherwise depart from the illustrated flow, provided that the process performed is operable and conforms to at least one claim.

Some embodiments provide or utilize a method for adjusting a data resource policy, the method performed (executed) by a computing system, the method including: obtaining 502 a data resource characterization 208 of a data resource 132; locating 504 a data resource policy 134 of the data resource; and conforming 506 the data resource policy to the data resource characterization.

In some embodiments, conforming 506 the data resource policy to the data resource characterization includes procuring 508 an optimal data resource policy 404 based on at least the data resource characterization, and changing 526 the located data resource policy by reducing 510 or removing 510 a gap 402 between the located data resource policy and the optimal data resource policy.

In some embodiments, conforming 506 the data resource policy to the data resource characterization includes procuring 508 an optimal data resource policy 404 based on at least the data resource characterization, and generating 512 a policy change recommendation 316. The policy change recommendation lists 514 a gap between the located data resource policy and the optimal data resource policy, and in some cases also lists 516 an option 412 for reducing or removing the gap.

In some embodiments, a recommendation model 314 looks at gaps 402 between optimal and existing access policy per a resource scope. The gaps can result from original misconfiguration, or from change in data overtime, or from a lack of awareness, for instance. The input for the model 314 is a logic that maps data to policy based on sensitivity (or another aspect of characterization 208), and additional features 416 describing data usage (such as access and management patterns). The model output 316 is a list of recommendations to the user allowing the user to reach a desired configuration quickly and easily.

Some embodiments support prioritizing certain resources over other resources, to help make sure the policies governing the prioritized resources are up to date. In some embodiments, the method includes: getting 518 a data resource set prioritization 310 which defines an ordered collection 308 of data resource sets 306, each data resource set having at least one associated data resource characterization 208 and at least one associated data resource policy 134; and performing 520 a prioritized collection 304 of policy adjustments 204 of at least some of the data resource sets 306, the performing based on the data resource set prioritization 310, each policy adjustment of a given data resource set including conforming 506 the data resource policy of the given data resource set to the data resource characterization of the given data resource set.

One example resource set prioritization 310 defines a resource set A as resources with category label ProjectResearch, and a resource set B as resources with criticality label ProjectCritical or criticality label AgencyCritical. The prioritization 310 also includes a list, or ranking values, or other data indicating A has greater priority than B. An example prioritized collection 304 of policy adjustments 204 specifies that exfiltration monitoring and multifactor authentication be required for set A, and that multifactor authentication be required for set B. Then the conforming 506 step will update or replace policies accordingly.

In some embodiments, the method includes acquiring 522 a data resource policy adjustment trigger definition 312 which defines when one or more of the obtaining 502, locating 504, and conforming 506 are permitted or required or both. In some, the data resource set adjustment trigger definition specifies at least one of: a time period 430 between data resource policy adjustments 204 (e.g., for specified resources, check 502, 504, 506 policy conformance every two days); or a trigger event 410 (e.g., check policy conformance whenever data is uploaded, or when a new employee is onboarded, or when there is a request to download more than ten files).

Some embodiments provide an option of conforming one policy for a set 306 of resources, e.g., all resources in a given account, all resources in a given folder, all resources in a given container, or a set specified dynamically. In some embodiments, the data resource characterization 208 is associated with a specified set 306 of data resources 132, and the data resource policy 134 is also associated with the specified set of data resources.

Some embodiments provide an option of adjusting policy when the policy is not working, regardless of whether the data characterization changed. In some embodiments, conforming 506 includes replacing 530 a first data resource policy with a second data resource policy, the first data resource policy was associated with the data resource at a first time 428, the replacing occurred at a second time 428, and the data resource characterization 208 did not change between the first time and the second time.

In some embodiments, conforming 506 the data resource policy to the data resource characterization includes: submitting 532 the data resource characterization 208 to an artificial intelligence model 314; procuring 508 an optimal data resource policy 404 from the artificial intelligence model in response to the submitting; and generating 512 a policy change recommendation 316, the policy change recommendation listing 514 a gap 402 between the located data resource policy and the optimal data resource policy also listing 516 an option 412 for reducing or removing the gap. In some embodiments, the submitting 532 includes submitting 532 the data resource characterization 208 to the artificial intelligence model 314 and also includes submitting 532 a data usage description 416 to the artificial intelligence model.

For example, a model 314 may be trained on data that correlates particular characterizations 208 with particular policy entries 426 consistent with one or more collections of best practices, e.g., cybersecurity guidance from the United States National Institute of Science and Technology, from the Open Web Application Security Project, from the MITRE Corporation, from the International Information Systems Security Certification Consortium, or from other widely recognized sources of cybersecurity best practices guidance. The particular correlations may vary between embodiments, or between models 314, or both. The best practices may also be represented in best practices data 118 that is accessible to software 302 for procuring 508 optimal policies and as a source of policy adjustments 204.

In some embodiments, the method includes obtaining 502 multiple data resource characterizations 208 of the data resource, and conforming 506 the data resource policy to the multiple data resource characterizations. For example, assume a resource has a top-secret sensitivity characterization 208, 420 and also has a geolocation restriction category characterization 208, 424. In this example, conforming 506 the data resource policy includes adding 534 an allowlist of users who can access to data if the policy does not already specify the allowlist restriction, and also includes adding 534 a geographic storage location restriction if the policy does not already specify the geographic storage location restriction.

More generally, in some embodiments or circumstances conforming 506 the data resource policy to the data resource characterization adds 534 an access restriction, thereby tightening security of the data resource. Unduly loose security puts data confidentiality or integrity at inappropriate risk. In other embodiments or circumstances conforming 506 the data resource policy to the data resource characterization removes 536 an access restriction, thereby loosening security of the data resource. Unduly tight security puts data availability at inappropriate risk, and imposes computational costs inefficiently.

Configured Storage Media

Some embodiments include a configured computer-readable storage medium 112. Storage medium 112 may include disks (magnetic, optical, or otherwise), RAM, EEPROMS or other ROMs, and/or other configurable memory, including in particular computer-readable storage media (which are not mere propagated signals). The storage medium which is configured may be in particular a removable storage medium 114 such as a CD, DVD, or flash memory. A general-purpose memory, which may be removable or not, and may be volatile or not, can be configured into an embodiment using items such as data resource policy adjustment software 302, adjustment trigger definitions 312, artificial intelligence models 314, policy change recommendations 316, policies 134, and data characterizations 208, in the form of data 118 and instructions 116, read from a removable storage medium 114 and/or another source such as a network connection, to form a configured storage medium. The configured storage medium 112 is capable of causing a computer system 202 to perform technical process steps for data resource policy adjustment, as disclosed herein. The Figures thus help illustrate configured storage media embodiments and process (a.k.a. method) embodiments, as well as system and process embodiments. In particular, any of the process steps illustrated in FIG. 5 or otherwise taught herein may be used to help configure a storage medium to form a configured storage medium embodiment.

Some embodiments use or provide a computer-readable storage device 112, 114 configured with data 118 and instructions 116 which upon execution by a processor 110 cause a computing system to perform a method of adjusting a data resource policy in a cloud computing environment. This method includes: obtaining 502 a data resource characterization 208 of a data resource 132 which resides in the cloud computing environment 136, 100; locating 504 a data resource policy 134 of the data resource; and conforming 506 the data resource policy to the data resource characterization.

In some embodiments, the data resource policy 134 specifies at least two of the following: a data resource sensitivity 420 characterization 208, a data resource criticality 422 characterization 208, or a data resource category 424 characterization 208.

In some embodiments, the data resource characterization 208 includes at least one of the following: a data resource sensitivity 420 score 406, or a data resource sensitivity 420 label 408.

In some embodiments, the data resource characterization 208 at least one of the following: a data resource criticality 422 score 406, or a data resource criticality 422 label 408.

In some embodiments, the data resource policy 134 specifies at least two of the following: a security token condition 432, an action 434 including a security token, a prohibition 436 including a security token, or an action 434 affecting a security token.

### ADDITIONAL OBSERVATIONS

Additional support for the discussion of data resource policy management functionality 206 herein is provided under various headings. However, it is all intended to be understood as an integrated and integral part of the present disclosure's discussion of the contemplated embodiments.

One of skill will recognize that not every part of this disclosure, or any particular details therein, are necessarily required to satisfy legal criteria such as enablement, written description, or best mode. Any apparent conflict with any other patent disclosure, even from the owner of the present innovations, has no role in interpreting the claims presented in this patent disclosure. With this understanding, which pertains to all parts of the present disclosure, examples and observations are offered herein.

Some embodiments perform or utilize resource policy adjustment based on data characterization in one or both of the following ways. In some embodiments, a system with an organizational policy makes sure that only allowed users or allowed services can access resources based on their sensitivity. The system can detect deviations from this policy adherence. In some embodiments, a recommendation system suggests access restrictions based on sensitivity. This recommendation system can be either fully autonomous or be semi-autonomous with some utilization of customer validation of suggestions. This recommendation system may also use the aforementioned organizational policy system.

Some embodiments make a distinction between sensitivity and criticality. In some, a “data sensitivity” indicates a confidentiality value, e.g., public, secret, etc., while a “data criticality” indicates a misuse impact value, e.g., no impact, corporate policy violation, regularity violation, legal risk, reputation risk, etc. In other words, labels on data could indicate sensitivity, but labels can also be used to indicate criticality. Data such as employees home addresses might be sensitive because it is secret but not be critical to any particular project. Conversely, data might be critical to a project but not be sensitive, e.g., a collection of email addresses craped from public web pages might be critical but not sensitive. Some embodiments dynamically update policies based on sensitivity labels, or based on criticality labels, or both.

Some embodiments make a distinction between sensitivity and category. In one example, “accounting” is a data category. Some accounting data might be public and other accounting data might be secret, some accounting data might be mission critical while other accounting data is not critical, but it's all accounting data, as opposed to marketing data, product development data, legal data, etc. Labels on data could indicate a category. Some embodiments dynamically update policies based on sensitivity labels, or based on category labels, or both.

Some embodiments provide or utilize dynamic adjustment of resource access policies based on data classification. By way of context, resource owners are generally able to set access tokens and policies to limit unwanted access to their resources. These policies and tokens are often based on default settings or inherited from higher level resources regardless of the actual criticality and sensitivity of the resources that they are created for. This leads to lax access policies governing sensitive information, which may lead to data leaks.

Some embodiments provide logic based on data classification results (e.g., sensitivity and criticality) that is used to limit the access policies, and limit security token lifetime and granularity. The logic is dynamic, adaptable to data change at different granularity levels, and doesn't require manual management.

In addition, some embodiments provide a recommendation system that continuously scans existing policies and suggests more optimal settings—especially in cases of a change of policy or a change in the kind of data. Scanning to classify is expensive, so some embodiments only scan modified content. A recommendation system can run in an automatic mode or an interactive mode, and may use logic described herein.

Some embodiments thus address the following problem. Access tokens and policies to govern important data may be not restrictive enough, unknowingly allowing unwanted or too broad access to critical and sensitive information. One of the reasons for this is that configuring an accurate access policy is often a hard and time-consuming task, which may involve manual permission assignment throughout an entire organization.

It's not unusual that when a resource is created, a non-restrictive access policy is created automatically, sometimes as a default or by inheritance from a parent resource. Later, sensitive data is added to this resource but the access policy or the existing tokens aren't updated to reflect the sensitivity change.

Another problem scenario is when a resource already contains sensitive data, and the owner is not aware of it. Due to this lack of knowledge, new access tokens 130 may be generated with long expiration periods and be handed off to unwanted parties, which in turn may lead to sensitive data leakage. Under various regulations, data leakage may result in high fines and compliance violations, and have other severe impact on organizations.

Restricting access based on data sensitivity and criticality will help reduce these risks significantly, with no need for manual intervention.

In some embodiments, a data classification feature scans the actual content of the resources, creating labels 408 for different data types 424 (e.g., financial, medical, government) and different sensitivity levels 420 (e.g., public, confidential, secret). Some embodiments use these labels 408 to reevaluate 506 the access level.

In some embodiments, sensitivity score calculation is an example of obtaining 502 a data resource characterization.

Some embodiments calculate a sensitivity score 406, 420 for a resource based on sensitivity of the resource's data or similar metrics such as criticality. For example, for a resource containing a weighted proportion S of sensitive items (e.g., a harmonic mean of contained items' individual sensitivity scores, giving more weight to highly sensitive ones), one can normalize this proportion to calculate the sensitivity score.

After the data is scanned and the sensitive types in it are revealed, the sensitivity score for this resource is calculated 502 and the access policy will be updated 506 (if not already accurate) to reflect its value. If a resource already has an existing access policy 134, it may automatically be updated 528, e.g., to restrict access to users who shouldn't have access to highly sensitive content, or expire existing access tokens if such are not allowed for it, or do both. For already scanned resources with a calculated high sensitivity score, a user attempt to generate an access token may result in a warning, an alert, a short-life token, or a complete denial, for example.

In some embodiments, a mapping 118 between users' allowed actions per sensitivity score can be set by the resource owner or by a relevant security person in the organization, such as a security officer in a Security Operations Center (SOC). This mapping is treated by the receiving embodiment as defining best practices. The access policy mapping can be different between the resource data levels. For example, one policy can be used for a storage container level, while a different policy may be used for a resource level, when the container is within the resource. When the mapping between allowed access operations and different sensitivity score values is set and enforced, the probability of unwanted access to sensitive data drops drastically.

Another benefit is that this security improvement is obtained without the manually configuring the access policy for each resource. Manual configuration of security policies is tedious, time-consuming, and error-prone. Manual policy management also tends to be at a high level of generality instead of being well tailored to each resource. Manual policy management typically does not account for changes in data, unlike automatic embodiments described herein.

In some embodiments, a recommendation model 314 operates in a fully automatic way, or in some cases in a semi-automatic way with human oversight to validate the model's output. The recommendation model looks at gaps 402 between optimal and existing access policy, per a resource scope (e.g., individual resource, or specified set 306 of resources 132). The gaps can result from original misconfiguration, change in data over time, or lack of awareness, for instance. An input for the model is logic that maps data to policy based on sensitivity 420, and in some cases on additional features 416 describing data usage such as access patterns or management patterns. The model output is a list of recommendations 316 to the user whose implementation allow the user to reach a desired configuration quickly and easily.

In some environments, access policies have been mostly based on higher level resources and permission inheritance. Some embodiments differ, by scanning and using the content of the data to characterize its sensitivity and criticality, which then guide conformance 506 of the access policy. This different approach will help to significantly reduce unwanted access to data and data leaks of sensitive data, thus reducing organizational risks associated with privacy, regulatory compliance, or economic impact from reputational harm.

Some embodiments also reduce or avoid manual access policy configuration, which requires tedious and error-prone work by admins or other people. Relying on such manual work invites access policy results that are too broad or too tight, which leads on the one hand to unwanted access to sensitive data, or on the other hand to an inability to properly work with sensitive data.

### Technical Character

The technical character of embodiments described herein will be apparent to one of ordinary skill in the art, and will also be apparent in several ways to a wide range of attentive readers. Some embodiments address technical activities such as calculating 502 sensitivity scores 406 based on digital data 118, 132, executing 512 a machine learning model 314, modifying 528 or replacing 530 access policy data structures 134, or adding 534 data access restrictions 418 in a cloud computing environment 136, which are each an activity deeply rooted in computing technology. Some of the technical mechanisms discussed include, e.g., data resource policy adjustment software 302, data characterizations 208, resource set prioritizations 310, interfaces 318, and artificial intelligence models 314. Some of the technical effects discussed include, e.g., decreased 510 gaps between located data resource policies 134 and optimal policies 404 which in turn provides more effective and efficient use of a system 210 to secure data resources 132, greater consistency in the management of data resource policies 134, and reduction of policy 134 management burdens on data owners, admins, and security personnel without sacrificing data security. Thus, purely mental processes and activities limited to pen-and-paper are clearly excluded. Other advantages based on the technical characteristics of the teachings will also be apparent to one of skill from the description provided.

Different embodiments may provide different technical benefits or other advantages in different circumstances, but one of skill informed by the teachings herein will acknowledge that particular technical advantages will likely follow from particular innovation features or feature combinations, as noted at various points herein.

Some embodiments described herein may be viewed by some people in a broader context. For instance, concepts such as efficiency, reliability, user satisfaction, or waste may be deemed relevant to a particular embodiment. However, it does not follow from the availability of a broad context that exclusive rights are being sought herein for abstract ideas; they are not. Rather, the present disclosure is focused on providing appropriately specific embodiments whose technical effects fully or partially solve particular technical problems, such as how to reliably identify and update a security policy 134 to match changes in the sensitivity or criticality of data 118 the policy is supposed to help protect, and how to make efficient and effective use of limited system resources (especially computing power and communications bandwidth) to secure data 118 within the system. Other configured storage media, systems, and processes involving efficiency, reliability, user satisfaction, or waste are outside the present scope. Accordingly, vagueness, mere abstractness, lack of technical character, and accompanying proof problems are also avoided under a proper understanding of the present disclosure.

### ADDITIONAL COMBINATIONS AND VARIATIONS

Any of these combinations of software code, data structures, logic, components, communications, and/or their functional equivalents may also be combined with any of the systems and their variations described above. A process may include any steps described herein in any subset or combination or sequence which is operable. Each variant may occur alone, or in combination with any one or more of the other variants. Each variant may occur with any of the processes and each process may be combined with any one or more of the other processes. Each process or combination of processes, including variants, may be combined with any of the configured storage medium combinations and variants described above.

More generally, one of skill will recognize that not every part of this disclosure, or any particular details therein, are necessarily required to satisfy legal criteria such as enablement, written description, or best mode. Also, embodiments are not limited to the particular scenarios, motivating examples, operating environments, peripherals, software process flows, identifiers, data structures, data selections, naming conventions, notations, control flows, or other implementation choices described herein. Any apparent conflict with any other patent disclosure, even from the owner of the present innovations, has no role in interpreting the claims presented in this patent disclosure.

### Acronyms, Abbreviations, Names, and Symbols

Some acronyms, abbreviations, names, and symbols are defined below. Others are defined elsewhere herein, or do not require definition here in order to be understood by one of skill.
ALU: arithmetic and logic unit
API: application program interface
BIOS: basic input/output system
CD: compact disc
CPU: central processing unit
DVD: digital versatile disk or digital video disc
FPGA: field-programmable gate array
FPU: floating point processing unit
GDPR: General Data Protection Regulation
GPU: graphical processing unit
GUI: graphical user interface
HTTPS: hypertext transfer protocol, secure
laaS or IAAS: infrastructure-as-a-service
ID: identification or identity
LAN: local area network
OS: operating system
PaaS or PAAS: platform-as-a-service
RAM: random access memory
ROM: read only memory
TPU: tensor processing unit
UEFI: Unified Extensible Firmware Interface
UI: user interface
WAN: wide area network

### Some Additional Terminology

Reference is made herein to exemplary embodiments such as those illustrated in the drawings, and specific language is used herein to describe the same. But alterations and further modifications of the features illustrated herein, and additional technical applications of the abstract principles illustrated by particular embodiments herein, which would occur to one skilled in the relevant art(s) and having possession of this disclosure, should be considered within the scope of the claims.

The meaning of terms is clarified in this disclosure, so the claims should be read with careful attention to these clarifications. Specific examples are given, but those of skill in the relevant art(s) will understand that other examples may also fall within the meaning of the terms used, and within the scope of one or more claims. Terms do not necessarily have the same meaning here that they have in general usage (particularly in non-technical usage), or in the usage of a particular industry, or in a particular dictionary or set of dictionaries. Reference numerals may be used with various phrasings, to help show the breadth of a term. Omission of a reference numeral from a given piece of text does not necessarily mean that the content of a Figure is not being discussed by the text. The inventors assert and exercise the right to specific and chosen lexicography. Quoted terms are being defined explicitly, but a term may also be defined implicitly without using quotation marks. Terms may be defined, either explicitly or implicitly, here in the Detailed Description and/or elsewhere in the application file.

A “computer system” (a.k.a. “computing system”) may include, for example, one or more servers, motherboards, processing nodes, laptops, tablets, personal computers (portable or not), personal digital assistants, smartphones, smartwatches, smart bands, cell or mobile phones, other mobile devices having at least a processor and a memory, video game systems, augmented reality systems, holographic projection systems, televisions, wearable computing systems, and/or other device(s) providing one or more processors controlled at least in part by instructions. The instructions may be in the form of firmware or other software in memory and/or specialized circuitry.

A “multithreaded” computer system is a computer system which supports multiple execution threads. The term “thread” should be understood to include code capable of or subject to scheduling, and possibly to synchronization. A thread may also be known outside this disclosure by another name, such as “task,” “process,” or “coroutine,” for example. However, a distinction is made herein between threads and processes, in that a thread defines an execution path inside a process. Also, threads of a process share a given address space, whereas different processes have different respective address spaces. The threads of a process may run in parallel, in sequence, or in a combination of parallel execution and sequential execution (e.g., time-sliced).

A “processor” is a thread-processing unit, such as a core in a simultaneous multithreading implementation. A processor includes hardware. A given chip may hold one or more processors. Processors may be general purpose, or they may be tailored for specific uses such as vector processing, graphics processing, signal processing, floating-point arithmetic processing, encryption, I/O processing, machine learning, and so on.

“Kernels” include operating systems, hypervisors, virtual machines, BIOS or UEFI code, and similar hardware interface software.

“Code” means processor instructions, data (which includes constants, variables, and data structures), or both instructions and data. “Code” and “software” are used interchangeably herein. Executable code, interpreted code, and firmware are some examples of code.

“Program” is used broadly herein, to include applications, kernels, drivers, interrupt handlers, firmware, state machines, libraries, and other code written by programmers (who are also referred to as developers) and/or automatically generated.

A “routine” is a callable piece of code which normally returns control to an instruction just after the point in a program execution at which the routine was called. Depending on the terminology used, a distinction is sometimes made elsewhere between a “function” and a “procedure”: a function normally returns a value, while a procedure does not. As used herein, “routine” includes both functions and procedures. A routine may have code that returns a value (e.g., sin(x)) or it may simply return without also providing a value (e.g., void functions).

“Service” means a consumable program offering, in a cloud computing environment or other network or computing system environment, which provides resources to multiple programs or provides resource access to multiple programs, or does both. A service implementation may itself include multiple applications or other programs.

“Cloud” means pooled resources for computing, storage, and networking which are elastically available for measured on-demand service. A cloud may be private, public, community, or a hybrid, and cloud services may be offered in the form of infrastructure as a service (laaS), platform as a service (PaaS), software as a service (SaaS), or another service. Unless stated otherwise, any discussion of reading from a file or writing to a file includes reading/writing a local file or reading/writing over a network, which may be a cloud network or other network, or doing both (local and networked read/write). A cloud may also be referred to as a “cloud environment” or a “cloud computing environment”.

“Access” to a computational resource includes use of a permission or other capability to read, modify, write, execute, move, delete, create, or otherwise utilize the resource. Attempted access may be explicitly distinguished from actual access, but “access” without the “attempted” qualifier includes both attempted access and access actually performed or provided.

As used herein, “include” allows additional elements (i.e., includes means comprises) unless otherwise stated.

“Optimize” means to improve, not necessarily to perfect. For example, it may be possible to make further improvements in a program or an algorithm which has been optimized.

“Process” is sometimes used herein as a term of the computing science arts, and in that technical sense encompasses computational resource users, which may also include or be referred to as coroutines, threads, tasks, interrupt handlers, application processes, kernel processes, procedures, or object methods, for example. As a practical matter, a “process” is the computational entity identified by system utilities such as Windows® Task Manager, Linux® ps, or similar utilities in other operating system environments (marks of Microsoft Corporation, Linus Torvalds, respectively). “Process” is also used herein as a patent law term of art, e.g., in describing a process claim as opposed to a system claim or an article of manufacture (configured storage medium) claim. Similarly, “method” is used herein at times as a technical term in the computing science arts (a kind of “routine”) and also as a patent law term of art (a “process”). “Process” and “method” in the patent law sense are used interchangeably herein. Those of skill will understand which meaning is intended in a particular instance, and will also understand that a given claimed process or method (in the patent law sense) may sometimes be implemented using one or more processes or methods (in the computing science sense).

“Automatically” means by use of automation (e.g., general purpose computing hardware configured by software for specific operations and technical effects discussed herein), as opposed to without automation. In particular, steps performed “automatically” are not performed by hand on paper or in a person's mind, although they may be initiated by a human person or guided interactively by a human person. Automatic steps are performed with a machine in order to obtain one or more technical effects that would not be realized without the technical interactions thus provided. Steps performed automatically are presumed to include at least one operation performed proactively.

One of skill understands that technical effects are the presumptive purpose of a technical embodiment. The mere fact that calculation is involved in an embodiment, for example, and that some calculations can also be performed without technical components (e.g., by paper and pencil, or even as mental steps) does not remove the presence of the technical effects or alter the concrete and technical nature of the embodiment, particularly in real-world embodiment implementations. Resource policy management operations such as calculating 502 or reading 502 a digital resource characterization value 208, locating 504 a data resource policy data structure 134, adjusting 526 a data resource policy data structure 134, communicating 532 with a machine learning model 314, and many other operations discussed herein, are understood to be inherently digital. A human mind cannot interface directly with a CPU or other processor, or with RAM or other digital storage, to read and write the necessary data to perform the resource policy management steps 500 taught herein even in a hypothetical prototype situation, much less in an embodiment's real world large computing environment. This would all be well understood by persons of skill in the art in view of the present disclosure.

“Computationally” likewise means a computing device (processor plus memory, at least) is being used, and excludes obtaining a result by mere human thought or mere human action alone. For example, doing arithmetic with a paper and pencil is not doing arithmetic computationally as understood herein. Computational results are faster, broader, deeper, more accurate, more consistent, more comprehensive, and/or otherwise provide technical effects that are beyond the scope of human performance alone. “Computational steps” are steps performed computationally. Neither “automatically” nor “computationally” necessarily means “immediately”. “Computationally” and “automatically” are used interchangeably herein.

“Proactively” means without a direct request from a user. Indeed, a user may not even realize that a proactive step by an embodiment was possible until a result of the step has been presented to the user. Except as otherwise stated, any computational and/or automatic step described herein may also be done proactively.

“Based on” means based on at least, not based exclusively on. Thus, a calculation based on X depends on at least X, and may also depend on Y.

Throughout this document, use of the optional plural “(s)”, “(es)”, or “(ies)” means that one or more of the indicated features is present. For example, “processor(s)” means “one or more processors” or equivalently “at least one processor”.

For the purposes of United States law and practice, use of the word “step” herein, in the claims or elsewhere, is not intended to invoke means-plus-function, step-plus-function, or 35 United State Code Section 112 Sixth Paragraph/Section 112(f) claim interpretation. Any presumption to that effect is hereby explicitly rebutted.

For the purposes of United States law and practice, the claims are not intended to invoke means-plus-function interpretation unless they use the phrase “means for”. Claim language intended to be interpreted as means-plus-function language, if any, will expressly recite that intention by using the phrase “means for”. When means-plus-function interpretation applies, whether by use of “means for” and/or by a court's legal construction of claim language, the means recited in the specification for a given noun or a given verb should be understood to be linked to the claim language and linked together herein by virtue of any of the following: appearance within the same block in a block diagram of the figures, denotation by the same or a similar name, denotation by the same reference numeral, a functional relationship depicted in any of the figures, a functional relationship noted in the present disclosure's text. For example, if a claim limitation recited a “zac widget” and that claim limitation became subject to means-plus-function interpretation, then at a minimum all structures identified anywhere in the specification in any figure block, paragraph, or example mentioning “zac widget”, or tied together by any reference numeral assigned to a zac widget, or disclosed as having a functional relationship with the structure or operation of a zac widget, would be deemed part of the structures identified in the application for zac widgets and would help define the set of equivalents for zac widget structures.

One of skill will recognize that this innovation disclosure discusses various data values and data structures, and recognize that such items reside in a memory (RAM, disk, etc.), thereby configuring the memory. One of skill will also recognize that this innovation disclosure discusses various algorithmic steps which are to be embodied in executable code in a given implementation, and that such code also resides in memory, and that it effectively configures any general-purpose processor which executes it, thereby transforming it from a general-purpose processor to a special-purpose processor which is functionally special-purpose hardware.

Accordingly, one of skill would not make the mistake of treating as non-overlapping items (a) a memory recited in a claim, and (b) a data structure or data value or code recited in the claim. Data structures and data values and code are understood to reside in memory, even when a claim does not explicitly recite that residency for each and every data structure or data value or piece of code mentioned. Accordingly, explicit recitals of such residency are not required. However, they are also not prohibited, and one or two select recitals may be present for emphasis, without thereby excluding all the other data values and data structures and code from residency. Likewise, code functionality recited in a claim is understood to configure a processor, regardless of whether that configuring quality is explicitly recited in the claim.

Throughout this document, unless expressly stated otherwise any reference to a step in a process presumes that the step may be performed directly by a party of interest and/or performed indirectly by the party through intervening mechanisms and/or intervening entities, and still lie within the scope of the step. That is, direct performance of the step by the party of interest is not required unless direct performance is an expressly stated requirement. For example, a computational step on behalf of a party of interest, such as acquiring, adding, adjusting, calculating, characterizing, collecting, conforming, decreasing, executing, generating, getting, listing, locating, managing, modifying, obtaining, performing, prioritizing, procuring, recommending, reducing, removing, replacing, securing, submitting, using, (and acquires, acquired, adds, added, etc.) with regard to a destination or other subject may involve intervening action, such as the foregoing or such as forwarding, copying, uploading, downloading, encoding, decoding, compressing, decompressing, encrypting, decrypting, authenticating, invoking, and so on by some other party or mechanism, including any action recited in this document, yet still be understood as being performed directly by or on behalf of the party of interest.

Whenever reference is made to data or instructions, it is understood that these items configure a computer-readable memory and/or computer-readable storage medium, thereby transforming it to a particular article, as opposed to simply existing on paper, in a person's mind, or as a mere signal being propagated on a wire, for example. For the purposes of patent protection in the United States, a memory or other computer-readable storage medium is not a propagating signal or a carrier wave or mere energy outside the scope of patentable subject matter under United States Patent and Trademark Office (USPTO) interpretation of the In re Nuijten case. No claim covers a signal per se or mere energy in the United States, and any claim interpretation that asserts otherwise in view of the present disclosure is unreasonable on its face. Unless expressly stated otherwise in a claim granted outside the United States, a claim does not cover a signal per se or mere energy.

Moreover, notwithstanding anything apparently to the contrary elsewhere herein, a clear distinction is to be understood between (a) computer readable storage media and computer readable memory, on the one hand, and (b) transmission media, also referred to as signal media, on the other hand. A transmission medium is a propagating signal or a carrier wave computer readable medium. By contrast, computer readable storage media and computer readable memory are not propagating signal or carrier wave computer readable media. Unless expressly stated otherwise in the claim, “computer readable medium” means a computer readable storage medium, not a propagating signal per se and not mere energy.

An “embodiment” herein is an example. The term “embodiment” is not interchangeable with “the invention”. Embodiments may freely share or borrow aspects to create other embodiments (provided the result is operable), even if a resulting combination of aspects is not explicitly described per se herein. Requiring each and every permitted combination to be explicitly and individually described is unnecessary for one of skill in the art, and would be contrary to policies which recognize that patent specifications are written for readers who are skilled in the art. Formal combinatorial calculations and informal common intuition regarding the number of possible combinations arising from even a small number of combinable features will also indicate that a large number of aspect combinations exist for the aspects described herein. Accordingly, requiring an explicit recitation of each and every combination would be contrary to policies calling for patent specifications to be concise and for readers to be knowledgeable in the technical fields concerned.

### LIST OF REFERENCE NUMERALS

The following list is provided for convenience and in support of the drawing figures and as part of the text of the specification, which describe innovations by reference to multiple items. Items not listed here may nonetheless be part of a given embodiment. For better legibility of the text, a given reference number is recited near some, but not all, recitations of the referenced item in the text. The same reference number may be used with reference to different examples or different instances of a given item. The list of reference numerals is:
100 operating environment, also referred to as computing environment; includes one or more systems 102
101 machine in a system 102, e.g., any device having at least a processor 110 and a memory 112 and also having a distinct identifier such as an IP address or a MAC (media access control) address; may be a physical machine or be a virtual machine implemented on physical hardware
102 computer system, also referred to as a “computational system” or “computing system”, and when in a network may be referred to as a “node”
104 users, e.g., user of an enhanced system 202; refers to a human or a human's online identity unless otherwise stated
106 peripheral device
108 network generally, including, e.g., LANs, WANs, software-defined networks, clouds, and other wired or wireless networks
110 processor; includes hardware
112 computer-readable storage medium, e.g., RAM, hard disks
114 removable configured computer-readable storage medium
116 instructions executable with processor; may be on removable storage media or in other memory (volatile or nonvolatile or both)
118 digital data in a system 102; data structures, values, mappings, software, tokens, and other examples are discussed herein
120 kernel(s), e.g., operating system(s), BIOS, UEFI, device drivers
122 tools and applications, e.g., version control systems, cybersecurity tools, software development tools, office productivity tools, social media tools, diagnostics, browsers, games, email and other communication tools, commands, and so on
124 user interface; hardware and software
126 display screens, also referred to as “displays”
128 computing hardware not otherwise associated with a reference number 106, 108, 110, 112, 114
130 security token; in a system 102, a token may serve as proof of authentication or proof of authorization or both; digital
132 resource in a system 102, e.g., data, software, hardware, or a combination thereof; a “data resource” includes data 118, and may include data that is not software, data that is also software, or data objects that represent hardware; some example resources include a virtual machine, an individual file or storage blob, a group of files, e.g., a folder or a directory subtree, and a storage account, but many other resources are also present in many systems 210
134 access policy as implemented in a system 102; digital data structure or computational or both; a resource policy is a set of rules, criteria, or restrictions governing activity that involves a resource and defines who can access the resource and what they can do with or to the resource; access policies and data loss prevention policies are some examples of resource policies
136 cloud, also referred to as cloud environment or cloud computing environment
202 managing computing system, i.e., system 102 enhanced with data resource policy adjustment functionality 206
204 policy adjustment as implemented or represented in a system 102, e.g., an updated policy 134 in which the update is a response to a mismatch between the prior version of the policy and a characterization 208 of the data the policy governs; policy adjustment may be distinguished from policy management in the sense that management includes checking to see whether an adjustment (policy update) is prudent while adjustment includes a policy update, but it is presumed that management will likely include an adjustment at some point, and therefore “policy adjustment” and “policy management” are used interchangeably herein to describe functionality 206
206 functionality for data resource policy management as taught herein; may also referred to as data resource policy adjustment functionality 206 or policy adjustment functionality 206; e.g., software or specialized hardware which performs or is configured to perform steps 502-506, or any software or hardware which performs or is configured to perform a method 500 or a computational data resource policy management activity first disclosed herein
208 data resource characterization, also referred to as data resource characterization; a digital value, or a computational activity which produces the digital value, in which the characterization digital value indicates a sensitivity 420, criticality 422, or category 424 of data 118; may be viewed as a generalization of data classification when classification is limited to secret, top-secret, etc. classification; a data resource characterization 208 may represent a sensitivity, a criticality, or a category, whereas a secret, top-secret, etc. classification is an example of a data resource characterization that represents sensitivity
210 managed system 102, that is, the system whose data resource 132 is governed with the policy 134; an object of functionality 206 activities
302 data resource policy adjustment software, e.g., software which provides functionality 206 upon execution with at least one processor 110
304 collection of policy adjustments in the form of digital instructions to adjust 526 a policy 134
306 set of resources 132 as represented digitally in a system 102; set 306 presumptively has at least two members unless otherwise indicated
308 collection of sets, as represented digitally in a system 102; may also be referred to as a set of sets
310 data resource set prioritization as represented digitally in a system 102, e.g., ordered list
312 resource policy adjustment trigger definition data structure in a system 102
314 machine learning model or expert system (also referred to as a “model”); computational
316 policy change recommendation, e.g., natural language directions or executable (which includes interpretable by a system 102) instructions for adjusting 526 a policy 134, or a mix thereof
318 interface generally; also refers in context to particular interfaces such as user interface 124, model 314 API, etc.
402 gap between two policies 134 or data structure representing such a gap; refers in particular to a gap between a located 504 policy and an optimal policy; gap 402 may be described or evaluated in terms of access, e.g., who is allowed access, what they can access, what operations they can perform, and under what conditions, including security token characteristics, authentication requirements, authorization requirements, auditing or other logging, monitoring, or filtering, for example; gap size may be measured, e.g., as a vector distance, or as a count in the number of different restrictions, or as a count of the number of users given access, or by other metrics or by a combination metric
404 optimal policy data structure, where optimality is assessed or defined according to security best practice as specified or adopted by an admin or security officer; may vary between embodiments or organizations, e.g., in one case an optimal policy for securing secret data may require multifactor authentication whereas in another case an optimal policy for securing secret data may call for either multifactor authentication or else a security token lifespan of under five minutes plus detailed user agent logging
406 score representing data sensitivity or data criticality; scores 406 fall within a specified numeric range whereas labels 408 come from a defined set of values that are not necessarily ordered relative to one another; digital
408 label representing data sensitivity, data criticality, or data category; labels may have an imposed order, e.g., public is less restrictive than secret which is less restrictive than top-secret; digital
410 policy adjustment trigger event; digital
412 gap-reduction option; example of a policy adjustment 204 presented to a user for approval or refusal as part of a change recommendation 316
414 data usage as represented in a system 102, e.g., history or pattern of access to data over time, or per user, or per department, or history or pattern of management of data such as archival, movement, exfiltration, or other interaction with data 118 or influence over interaction with data 118
416 digital data structure representing data usage 414
418 access restriction as represented in a system 102, e.g., authentication or authorization condition for access; digital, computational, or both
420 data sensitivity as represented in a system 102; may indicate a confidentiality value, e.g., public, secret, etc.
422 data criticality as represented in a system 102; may indicate a misuse impact value, e.g., no impact, corporate policy violation, regularity violation, legal risk, reputation risk, etc.; may be associated with a financial estimate of the cost of recovering from the impact; may be associated with a time estimate, e.g., a product release delay if the data is lost or corrupted; may also be referred to as “severity”
424 data category as represented in a system 102; may indicate a data origin, ownership, or type, e.g., accounting, health, subject to GDPR, etc.
426 entry in a policy 134, e.g., statement, clause, provision, restriction, or other logical sub-portion of a policy
428 time generally, as represented in a system 102; may be wall clock time or internal system time, depending on context (wall clock is presumed)
430 time period as represented in a system 102, e.g., span of time, duration, reoccurrence interval; digital
432 security token condition as implemented in a system 102
434 action in a system 102 taken upon a security token or otherwise involving a security token
436 security token prohibition as implemented in a system 102
500 flowchart; 500 also refers to data resource policy adjustment methods that are illustrated by or consistent with the FIG. 5 flowchart
502 computationally obtain resource data characterization, e.g., by retrieving a previously calculated or assigned characterization 208 or by calculating a current characterization 208
504 computationally locate a data resource policy 134, e.g., using an API
506 computationally conform a policy 134 to a characterization 208, e.g., by confirming that the policy 134 matches the characterization 208 per a best practice data structure, or by adjusting 526 the policy 134 to make it match the characterization 208, or by generating 512 a recommendation for policy changes that will bring the policy closer to a full match with the data resource characterization; unless expressly stated otherwise, conforming does not alter the characterization 208
508 computationally procure an optimal policy 404 for a given characterization 208, e.g., by reading a best practice data structure 118
510 computationally decrease (reduce or remove) a gap 402 between policies by adjusting one of the policies
512 computationally generate a policy change recommendation, e.g., based on a current policy 134 and a best practice data structure 118; a model 314 may also or alternately be trained to generate change recommendations based on commonly encountered scenarios such as the addition of more sensitive data, the detection of a breach, an upgrade to more widespread use of multifactor authentication, and so on
514 computationally list a gap, e.g., by configuring a display with human-readable text
516 computationally list a gap-reduction option, e.g., by configuring a display with human-readable text
518 computationally get a prioritization, e.g., using an API
520 computationally perform prioritized changes 204, e.g., by changing settings or configuration file content, executing commands in a script, or executing a wizard which guides a human user through actions that invoke computation to perform prioritized changes
522 computationally acquire a policy adjustment trigger definition, e.g., via a user interface 124 or API
524 computationally use a policy adjustment trigger definition, e.g., to determine which data resource to check for conformance 506 at which time or in which order
526 computationally adjust a policy by modifying 528 or replacing 530 the policy; may also be referred to as making an adjustment 204
528 computationally modify a policy by 528
530 computationally replace a policy by 528; any modifying 528 may be understood to be also achievable by a suitable replacing 530, and vice versa
532 computationally submit data to a model 314, e.g., via an API; subsequently computationally receiving data from the model in response to the submission is also contemplated per the teachings herein
534 computationally add an access restriction to a policy 134 or pursuant to a policy 134
536 computationally remove an access restriction from a policy 134 or pursuant to a policy 134
538 any step discussed in the present disclosure that has not been assigned some other reference numeral; 538 may thus be shown expressly as a reference numeral for various steps, and may be added as a reference numeral for various steps without thereby adding new matter to the present disclosure

### CONCLUSION

In short, the teachings herein provide a variety of data resource policy adjustment functionalities 206 which operate in enhanced systems 202. Some embodiments automatically reduce 510 or remove 510 gaps 402 between a data resource's 132 actual policy 134 and an optimal policy 404. Policy gaps 402 may arise when a different kind 208 of data 118 is added to the resource 132 after the policy 134 was set, or when the original policy 134 is deemed inadequate or overly restrictive, for example. An embodiment obtains 502 a characterization 208 of the resource's data 118 in terms of sensitivity 420, criticality 422, or category 424, captured in scores 406 or labels 408. The embodiment locates 504 the resource's current policy 134, and conforms 506 the policy 134 with best practices, by modifying 528 or replacing 530 the policy 134 as indicated. Policy adjustments 204 may implement recommendations 316 that were generated 512 by an artificial intelligence model 314. Policy adjustments 204 may be periodic 430, ongoing, or driven by specified trigger events 410. Security token 130 conditions 432, actions 434, or prohibitions 436 may be added 534, removed 536, or modified 204. Policy conformance 506 of particular resource sets 306 may be prioritized 310, 520. Automated policy conformance 506 improves security, operational consistency, and computational efficiency, and relieves personnel of tedious and error-prone tasks.

Embodiments are understood to also themselves include or benefit from tested and appropriate security controls and privacy controls such as the General Data Protection Regulation (GDPR). Use of the tools and techniques taught herein is compatible with use of such controls.

Although Microsoft technology is used in some motivating examples, the teachings herein are not limited to use in technology supplied or administered by Microsoft. Under a suitable license, for example, the present teachings could be embodied in software or services provided by other cloud service providers.

Although particular embodiments are expressly illustrated and described herein as processes, as configured storage media, or as systems, it will be appreciated that discussion of one type of embodiment also generally extends to other embodiment types. For instance, the descriptions of processes in connection with the Figures also help describe configured storage media, and help describe the technical effects and operation of systems and manufactures like those discussed in connection with other Figures. It does not follow that any limitations from one embodiment are necessarily read into another. In particular, processes are not necessarily limited to the data structures and arrangements presented while discussing systems or manufactures such as configured memories.

Those of skill will understand that implementation details may pertain to specific code, such as specific thresholds, comparisons, specific kinds of platforms or programming languages or architectures, specific scripts or other tasks, and specific computing environments, and thus need not appear in every embodiment. Those of skill will also understand that program identifiers and some other terminology used in discussing details are implementation-specific and thus need not pertain to every embodiment. Nonetheless, although they are not necessarily required to be present here, such details may help some readers by providing context and/or may illustrate a few of the many possible implementations of the technology discussed herein.

With due attention to the items provided herein, including technical processes, technical effects, technical mechanisms, and technical details which are illustrative but not comprehensive of all claimed or claimable embodiments, one of skill will understand that the present disclosure and the embodiments described herein are not directed to subject matter outside the technical arts, or to any idea of itself such as a principal or original cause or motive, or to a mere result per se, or to a mental process or mental steps, or to a business method or prevalent economic practice, or to a mere method of organizing human activities, or to a law of nature per se, or to a naturally occurring thing or process, or to a living thing or part of a living thing, or to a mathematical formula per se, or to isolated software per se, or to a merely conventional computer, or to anything wholly imperceptible or any abstract idea per se, or to insignificant post-solution activities, or to any method implemented entirely on an unspecified apparatus, or to any method that fails to produce results that are useful and concrete, or to any preemption of all fields of usage, or to any other subject matter which is ineligible for patent protection under the laws of the jurisdiction in which such protection is sought or is being licensed or enforced.

Reference herein to an embodiment having some feature X and reference elsewhere herein to an embodiment having some feature Y does not exclude from this disclosure embodiments which have both feature X and feature Y, unless such exclusion is expressly stated herein. All possible negative claim limitations are within the scope of this disclosure, in the sense that any feature which is stated to be part of an embodiment may also be expressly removed from inclusion in another embodiment, even if that specific exclusion is not given in any example herein. The term “embodiment” is merely used herein as a more convenient form of “process, system, article of manufacture, configured computer readable storage medium, and/or other example of the teachings herein as applied in a manner consistent with applicable law.” Accordingly, a given “embodiment” may include any combination of features disclosed herein, provided the embodiment is consistent with at least one claim.

Not every item shown in the Figures need be present in every embodiment. Conversely, an embodiment may contain item(s) not shown expressly in the Figures. Although some possibilities are illustrated here in text and drawings by specific examples, embodiments may depart from these examples. For instance, specific technical effects or technical features of an example may be omitted, renamed, grouped differently, repeated, instantiated in hardware and/or software differently, or be a mix of effects or features appearing in two or more of the examples. Functionality shown at one location may also be provided at a different location in some embodiments; one of skill recognizes that functionality modules can be defined in various ways in a given implementation without necessarily omitting desired technical effects from the collection of interacting modules viewed as a whole. Distinct steps may be shown together in a single box in the Figures, due to space limitations or for convenience, but nonetheless be separately performable, e.g., one may be performed without the other in a given performance of a method.

Reference has been made to the figures throughout by reference numerals. Any apparent inconsistencies in the phrasing associated with a given reference numeral, in the figures or in the text, should be understood as simply broadening the scope of what is referenced by that numeral. Different instances of a given reference numeral may refer to different embodiments, even though the same reference numeral is used. Similarly, a given reference numeral may be used to refer to a verb, a noun, and/or to corresponding instances of each, e.g., a processor 110 may process 110 instructions by executing them.

As used herein, terms such as “a”, “an”, and “the” are inclusive of one or more of the indicated item or step. In particular, in the claims a reference to an item generally means at least one such item is present and a reference to a step means at least one instance of the step is performed. Similarly, “is” and other singular verb forms should be understood to encompass the possibility of “are” and other plural forms, when context permits, to avoid grammatical errors or misunderstandings.

Headings are for convenience only; information on a given topic may be found outside the section whose heading indicates that topic.

All claims and the abstract, as filed, are part of the specification. The abstract is provided for convenience and for compliance with patent office requirements; it is not a substitute for the claims and does not govern claim interpretation in the event of any apparent conflict with other parts of the specification. Similarly, the summary is provided for convenience and does not govern in the event of any conflict with the claims or with other parts of the specification. Claim interpretation shall be made in view of the specification as understood by one of skill in the art; innovators are not required to recite every nuance within the claims themselves as though no other disclosure was provided herein.

To the extent any term used herein implicates or otherwise refers to an industry standard, and to the extent that applicable law requires identification of a particular version of such as standard, this disclosure shall be understood to refer to the most recent version of that standard which has been published in at least draft form (final form takes precedence if more recent) as of the earliest priority date of the present disclosure under applicable patent law.

While exemplary embodiments have been shown in the drawings and described above, it will be apparent to those of ordinary skill in the art that numerous modifications can be made without departing from the principles and concepts set forth in the claims, and that such modifications need not encompass an entire abstract concept. Although the subject matter is described in language specific to structural features and/or procedural acts, it is to be understood that the subject matter defined in the appended claims is not necessarily limited to the specific technical features or acts described above the claims. It is not necessary for every means or aspect or technical effect identified in a given definition or example to be present or to be utilized in every embodiment. Rather, the specific features and acts and effects described are disclosed as examples for consideration when implementing the claims.

All changes which fall short of enveloping an entire abstract idea but come within the meaning and range of equivalency of the claims are to be embraced within their scope to the full extent permitted by law.

What is claimed is:

1. A managing computing system which is configured to manage a data resource policy of a managed system, the managing system comprising:
a digital memory;
at least one processor in operable communication with the digital memory, the at least one processor configured to collectively perform resource policy adjustment based on data characterization including automatically: obtaining a data resource characterization of a data resource, locating a data resource policy of the data resource, and conforming the data resource policy to the data resource characterization.

2. The managing computing system of claim 1 in combination with the data resource policy of the data resource, wherein the data resource policy includes an entry which specifies at least one of the following:
a data resource sensitivity characterization;
a data resource criticality characterization; or
a data resource category characterization.

3. The managing computing system of claim 1 in combination with the data resource characterization of the data resource, wherein the data resource characterization includes at least one of the following:
a data resource sensitivity score;
a data resource criticality score;
a data resource sensitivity label;
a data resource criticality label;
a data resource category label; or
a set of multiple data resource labels.

4. The managing computing system of claim 1 in combination with the data resource policy of the data resource, wherein the data resource policy includes an entry specifying at least one of:
a security token condition;
an action including a security token;
a prohibition including a security token; or
an action affecting a security token.

5. A method of adjusting a data resource policy, the method comprising automatically:
obtaining a data resource characterization of a data resource;
locating a data resource policy of the data resource; and
conforming the data resource policy to the data resource characterization.

6. The method of claim 5, wherein conforming the data resource policy to the data resource characterization comprises: procuring an optimal data resource policy based on at least the data resource characterization, and changing the located data resource policy by reducing or removing a gap between the located data resource policy and the optimal data resource policy.

7. The method of claim 5, wherein conforming the data resource policy to the data resource characterization comprises:
procuring an optimal data resource policy based on at least the data resource characterization; and
generating a policy change recommendation, the policy change recommendation listing a gap between the located data resource policy and the optimal data resource policy also listing an option for reducing or removing the gap.

8. The method of claim 5, further comprising:
getting a data resource set prioritization which defines an ordered collection of data resource sets, each data resource set having at least one associated data resource characterization and at least one associated data resource policy; and
performing a prioritized collection of policy adjustments of at least some of the data resource sets, the performing based on the data resource set prioritization, each policy adjustment of a given data resource set including conforming the data resource policy of the given data resource set to the data resource characterization of the given data resource set.

9. The method of claim 5, further comprising acquiring a data resource policy adjustment trigger definition which defines when one or more of the obtaining, locating, and conforming are permitted or required or both, and wherein the data resource set adjustment trigger definition specifies at least one of:
a time period between data resource policy adjustments; or
a trigger event.

10. The method of claim 5, wherein the data resource characterization is associated with a specified set of data resources, and the data resource policy is also associated with the specified set of data resources.

11. The method of claim 5, wherein conforming includes replacing a first data resource policy with a second data resource policy, the first data resource policy was associated with the data resource at a first time, the replacing occurred at a second time, and the data resource characterization did not change between the first time and the second time.

12. The method of claim 5, wherein conforming the data resource policy to the data resource characterization comprises:
submitting the data resource characterization to an artificial intelligence model;
procuring an optimal data resource policy from the artificial intelligence model in response to the submitting; and
generating a policy change recommendation, the policy change recommendation listing a gap between the located data resource policy and the optimal data resource policy also listing an option for reducing or removing the gap.

13. The method of claim 12, wherein submitting comprises submitting the data resource characterization to the artificial intelligence model and also comprises submitting a data usage description to the artificial intelligence model.

14. The method of claim 5, comprising obtaining multiple data resource characterizations of the data resource; and conforming the data resource policy to the multiple data resource characterizations.

15. The method of claim 5, wherein conforming the data resource policy to the data resource characterization adds an access restriction, thereby tightening security of the data resource.

16. A computer-readable storage device configured with data and instructions which upon execution by a processor cause a computing system to perform method of adjusting a data resource policy in a cloud computing environment, the method comprising:
obtaining a data resource characterization of a data resource which resides in the cloud computing environment;
locating a data resource policy of the data resource; and
conforming the data resource policy to the data resource characterization.

17. The computer-readable storage device of claim 16, wherein the data resource policy specifies at least two of the following:
a data resource sensitivity characterization;
a data resource criticality characterization; or
a data resource category characterization.

18. The computer-readable storage device of claim 16, wherein the data resource characterization includes at least one of the following:
a data resource sensitivity score; or
a data resource sensitivity label.

19. The computer-readable storage device of claim 16, wherein the data resource characterization includes at least one of the following:
a data resource criticality score; or
a data resource criticality label.

20. The computer-readable storage device of claim 16, wherein the data resource policy specifies at least two of the following:
a security token condition;
an action including a security token;
a prohibition including a security token; or
an action affecting a security token.
